(19) United States
(12) Patent Application Publication
(10) Pub. No.: US 2016/0071490 A1
(43) Pub. Date: Mar. 10, 2016

(54) ELECTRONIC INFORMATION LABEL FOR DISPLAYING INFORMATION AND DISPLAY CONTROL METHOD THEREOF

(71) Applicant: Samsung Electro-Mechanics Co., Ltd., Suwon-si (KR)

(72) Inventors: In Wha JEONG, Suwon-si (KR); Jong Heum PARK, Suwon-si (KR); Hak Ryong KIM, Suwon-si (KR); Ju Yong KIM, Suwon-si (KR)

(73) Assignee: Samsung Electro-Mechanics Co., Ltd., Suwon-si (KR)

(21) Appl. No.: 14/716,246

(22) Filed: May 19, 2015

(30) Foreign Application Priority Data
Sep. 10, 2014 (KR) 10-2014-0119614

(51) Int. Cl. G09G 5/14; G02B 5/30; G02B 5/20; G06F 3/14

(52) U.S. Cl. CPC G09G 5/14; G06F 3/1423; G02B 5/3025; G02B 5/20; G09G 2380/04; G09G 2380/08; G09G 2358/00; G09G 2320/0613

(57) ABSTRACT

An electronic label electronically displaying information, and a display control method of the electronic label. The electronic label includes a first display configured to have front and back surfaces with polarizing filters attached on the both surfaces, respectively, and display, on the front surface, information that is able to be seen with bare eyes, a second display configured to have front and back surfaces with a polarizing filter attached only on the back surface, and display, on the front surface, information that is unable to be seen with bare eyes, a communication module configured to communicate with a server or a gateway, a memory configured to store information received through the communication module, and a controller configured to control operations of the first display and the second display.

### CROSS-REFERENCE TO RELATED APPLICATION(S)

This application claims priority from Korean Patent Application No. 10-2014-0119614, filed on Sep. 10, 2014, in the Korean Intellectual Property Office, the entire disclosure of which is incorporated herein by reference for all purposes.

### BACKGROUND

1. Field

The following description relates to an electronic label that displays information electronically.

2. Description of the Related Art

An Electric Information Label (EIL, hereinafter referred to as ‘electronic label’) is an electronic device that replaces a paper label that displays information (for example, name, price, and origin) of products on store shelves. EILs managed by the same relay station may form a group, and the whole EILs are separated into these groups, and information is managed according to the separated groups. To reduce power consumption of an electronic label, which is battery-powered, the electronic label maintains in a sleep mode except for a wake-up period required for information update. During a wake-up period, an electronic label listens to communication from a server, and, if there is data to be received from the server, the electronic label receives and stores the data.

Electronic labels are used mainly for store shelves. Information displayed on an electronic label is able to be seen with bare eyes. However, some information to be displayed on an electronic label should be available only for specific people.

A Liquid Crystal Display (LCD) apparatus has polarizing films attached on the front and back surfaces of a LCD panel. The polarizing films allow only a wave polarized in a predetermined direction from incident light to pass. The two polarizing films with polarization aligned orthogonal to each other perform optical switching in cooperation with a liquid panel with optical activities.

### SUMMARY

The following description relates to an electronic label that determines a type of information to be public information or non-public information according to whether the information needs to be protected, and then displays the information.

In addition, the following description relates to a technology for reducing power consumption of an electronic label which has two display areas: one display area is for displaying information that can be seen with bare eyes, and the other display area is for displaying information that cannot be seen with bare eyes.

Furthermore, the following description relates to an electronic label that electronically displays information that is periodically updated.

According to one general aspect, an electronic label has a display panel with a polarizing filter is not attached in part of the display panel.

Information unable to be seen with bare eyes is displayed on the part of the display panel where the polarizing filter is not attached.

According to another general aspect, information displayed on an electronic label is updated in accordance with information received over a network.

According to yet another general aspect, a first display is an Electronic Paper Display (EPD).

According to yet another general aspect, a controller makes a determination as to information received from a server or a gateway through a communication module and displays the information according to the determination.

Other features and aspects may be apparent from the following detailed description, the drawings, and the claims.

### BRIEF DESCRIPTION OF THE DRAWINGS

FIG. 1 is a block diagram illustrating a configuration of an electronic label according to an exemplary embodiment.

FIG. 2 is a diagram illustrating a configuration of an electronic label with the first and second displays that are embodied as Liquid Crystal Displays (LCDs) according to an exemplary embodiment.

FIG. 3 is a diagram illustrating a configuration of an electronic label with the first display that is embodied as an Electronic Paper Display (EPD) according to an exemplary embodiment.

FIG. 4 is a diagram illustrating a polarizer according to an exemplary embodiment.

FIG. 5 is a diagram illustrating contexts displayed on the first and second displays of an electronic label according to an exemplary embodiment.

FIGS. 6 and 7 are diagrams illustrating an electronic label attached on a patient's bed in a ward. Specifically, FIG. 6 shows information displayed by the electronic label, and FIG. 7 shows information that is seen when a polarizer is put close to the second display of the electronic label.

FIGS. 8 and 9 are diagrams illustrating an electronic label attached on a door of a ward according to an exemplary embodiment. Specifically, FIG. 8 shows information displayed by the electronic label, and FIG. 9 shows information that is seen when an object with a polarizing function is put close to the second display of the electronic label.

FIG. 10 is a diagram illustrating a configuration of an electronic label system according another exemplary embodiment.

FIG. 11 is a flowchart illustrating a displaying method of an electronic label according to an exemplary embodiment.

FIG. 12 is a flowchart illustrating a method in which an electronic label receives information directly from a server and displays the received information according to an exemplary embodiment.

FIG. 13 is a flowchart illustrating a method in which an electronic label receives information through a gateway from a server and displays the received information according to an exemplary embodiment.

Throughout the drawings and the detailed description, unless otherwise described, the same drawing reference numerals will be understood to refer to the same elements, features, and structures. The relative size and depiction of these elements may be exaggerated for clarity, illustration, and convenience.

### DETAILED DESCRIPTION

The following description is provided to assist the reader in gaining a comprehensive understanding of the methods, apparatuses, and/or systems described herein. Accordingly, various changes, modifications, and equivalents of the methods, apparatuses, and/or systems described herein will be suggested to those of ordinary skill in the art. Also, descriptions of well-known functions and constructions may be omitted for increased clarity and conciseness.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

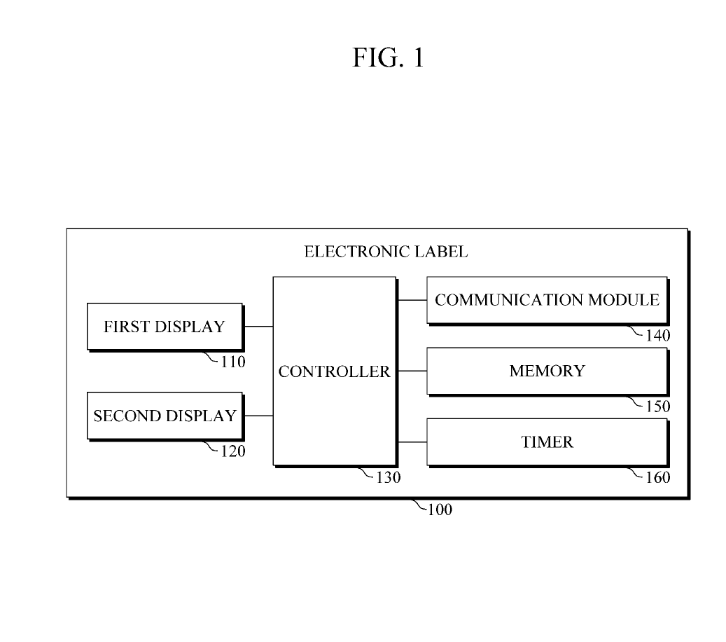

FIG. 1 is a block diagram illustrating a configuration of an electronic label according to an exemplary embodiment. For example, an electronic label 100 may be attached to a door of a ward or to a patient bed in the hospital to display patient information.

Referring to FIG. 1, the electronic label 100 includes a first display 110, a second display 120, a controller 130, a communication module 140, and a memory 150.

The first display 110 includes two polarizing filters attached on the front and back surfaces thereof. The front surface of the first display 110 displays information that can be seen with bare eyes. The first display 110 may be a Liquid Crystal Display (LCD).

According to the driving methods, the LCD may be divided into the Passive Matrix LCD (PM LCD) consisting of a grid of positive and negative conductors to form a pixel and the Active Matrix LCD (AM LCD) having TFT that serves as a switch at each pixel. There are a normally white mode and a normally black mode according to whether lights are able to pass through an LCD when voltage is applied.

The LCD consists of two glass plates with liquid materials injected there between and two polarizing filters respectively attached on the two glass panels. The LCD displays a character or an image by switching lights using a change in optical properties of the lights, the change which occurs when voltage is applied to a TFT on one glass plate and transparent electrodes on the other glass plate to cause liquid molecules to be rearranged at each pixel.

The two polarizing filters may be arranged vertical to each other. A polarizing filter or film filters out only polarized light vibrating in one direction by restricting vibration directions of lights entering to an LCD display panel.

When incident lights from the back light of the LCD panel pass through the first polarizing filter attached on the back surface of the LCD panel, only lights vibrating in a direction which is the same as a polarization axis of the first polarizing filter are able to pass. Then, as being twisted according to an orientation and applied voltage, the lights vibrating in a direction which is the same as the polarization axis of the first polarizing filter pass through aligned liquid crystals, so that the polarization direction of light is changed according to optical rotary power of the liquid crystals. Then, when the light passes through the second polarizing filter attached on the front surface of the LCD panel, light vibrating in a direction which is the same as a polarization axis of the second polarizing filter is able to pass. As an orientation in which liquid crystals are aligned at each pixel is electrically controlled, lights may be effectively switched on the liquid crystal panel and specific information may be visually displayed.

The second display 120 includes a polarizing filter attached only on the back surface thereof without an additional polarizing filter attached on the front surface, and displays information that is unable to be seen with bare eyes. In other words, similar to the first display 110, the second display 120 includes a polarizing filter attached on the back surface thereof. However, unlike the first display 110, the second display 120 does not include a polarizing filter attached on the front surface thereof.

If a polarizing filter is not attached on the front surface of an LCD panel, light may not be filtered by the second polarizing filter after having passed through liquid crystals and the first polarizing filter attached on the back surface of the LCD panel. As a result, any light polarized in any direction and even non-polarized light may pass through the LCD panel, and thus, information displayed on the LCD panel is unable to be seen with bare eyes. Information to be displayed on the second display 120 is able to be seen only by using a polarizer that allows only light vibrating in a specific direction to pass.

The polarizer includes an additional external polarizing film, a polarizing filter, a polarizing plate, a polarizing stick, polarizing glasses, and the like. However, aspects of the present disclosure are not limited thereto. That is, the polarizer may be any element that allows only light of a specific direction to pass. For example, a medical chart used in the hospital may include a polarizing film or a polarizing plate. In another example, a polarizing film may be portable, just like a stethoscope. In yet another example, the medical staff may wear polarizing glasses. If any doctor or nurse wear polarizing glasses or put a polarizing film/polarizing plate close to a patient's electronic label attached on the door of the patient's ward or bed, the polarizing glasses, polarizing film, or polarizing plate may allow only a light wave vibrating in a specific direction to pass, and thus, the medical staff may be able to see the patient's non-public information displayed on the second display 120.

Thus, any visitor or a third party who does not have any polarizer is not able to see the patient's non-public information displayed on the second display 120.

The controller 130 controls operations of the first display 110 and the second display 120. Specifically, the controller 130 controls information received from the server 800 or the gateway 900 to be stored in the memory 150, and controls the received information to be displayed on the first display 110 or the second display 120 according to a type of the received information. Herein, a type of information is determined to be public information or non-public information depending on whether the information needs to be protected.

The communication module 140 communicates with the server 800 or the gateway 900. The electronic label 100 may receive information directly from the server 800 or through the gateway 900. When transmitting or receiving information with respect to the server 800 or the gateway 900, the electronic label 100 may be connected to the server 800 or the gateway 900 over a wireless network such as WiFi or Zigbee. However, if necessary, the electronic label 100 may be connected to the server 800 or the gateway 900 over a wired network. In another example, the electronic label 100 may receive data from a terminal, such as a mobile phone, through Near Field Communication (NFC), WiFi, Ultra-Wideband (UWB), Bluetooth, or the like.

The memory 150 stores information received from the server 800 or the gateway 900. The received information may include patient information which is described in detail with reference to the following drawings.

According to an exemplary embodiment, the electronic label 100 may further include a timer 160.

The timer 160 may operate even when the controller 130 remains in a sleep mode. The timer 160 generates an interrupt signal at predetermined time intervals set by the controller to wake up the controller 130. A wake-up time slot of each electronic label may be determined by an electronic label management server in a manner that does not cause a conflict between electronic labels.

The controller 130 is periodically woken up from a sleep mode by the timer 160. By applying the wake-up technique to the controller 130, the electronic label 100 may use less power to communicate with the server 800 or the gateway 900.

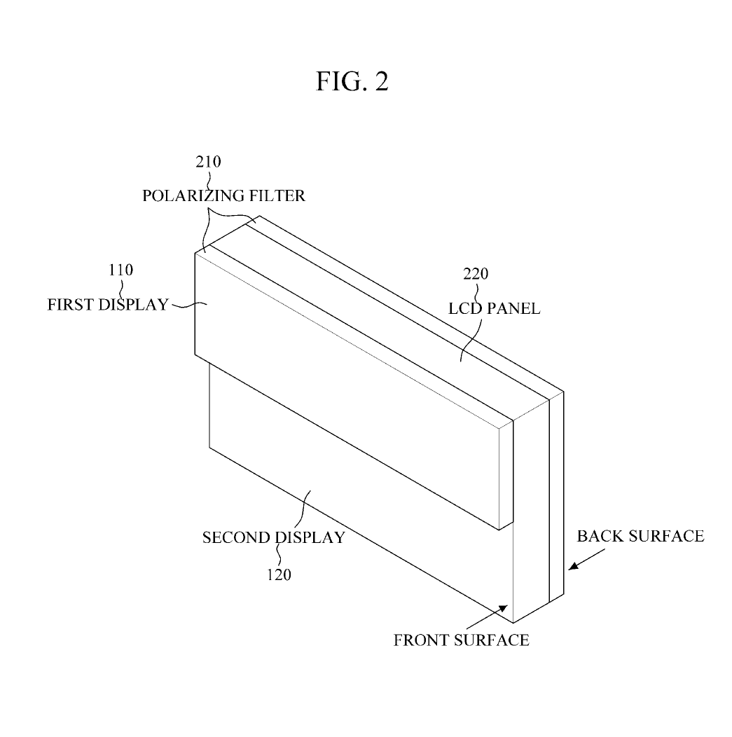

FIG. 2 is a diagram illustrating a configuration of an electronic label of which the first and second displays are embodied as LCDs according to an exemplary embodiment.

Referring to FIG. 2, the first display 110 of the electronic label 100 has two polarizing filters 210 that are respectively attached on the front and back surfaces of the LCD panel 220. The second display 120 of the electronic label 100 has only one polarizing filter 210 attached on the back surface of the LCD panel 220. Information to be displayed on the first display 110 may be seen with bare eyes, but information to be displayed on the second display 120 may not be seen without a polarizer. That is, only when the polarizer allows only lights vibrating in a direction indicating particular information to pass, it is possible to see the particular information with bare eyes.

According to one general aspect of the present disclosure, the first and second displays 110 and 120 may be embodied as a display panel with a polarizing filter attached on part of the front surface thereof. That is, the first and second displays 110 and 120 may be a physically single display. In this case, an area of the front surface where the polarizing filter is attached is the first display 110, and the rest area is the second display 120.

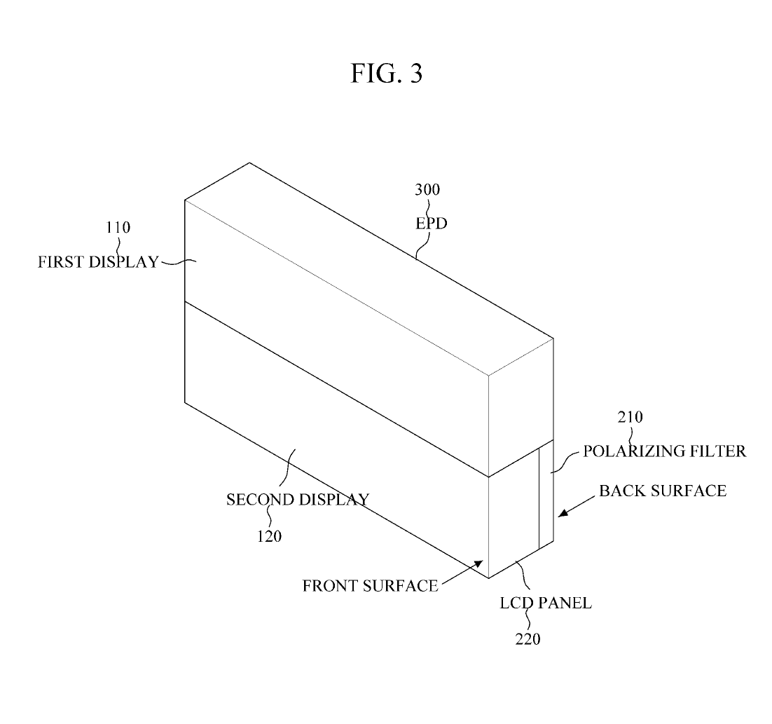

FIG. 3 is a diagram illustrating an Electronic Paper Display (EPD) that is the first display of an electronic label according to an exemplary embodiment.

Referring to FIG. 3, the first display 110 of the electronic label 100 may be an EPD, and the second display 120 is an LCD panel. The first display 110 is driven by an EPD display driving circuit. The second display 120 is driven by an LCD display driving circuit. In FIG. 3, the first display 110 and the second display 120 are physically separate displays, and may be integrated by connecting to each other.

An LCD can be driven with low voltage and is useful in displaying a full color image of high quality. An EPD 300 does not require light source, and is able to be bent like paper and maintains displaying an image without power supply.

Information to be displayed on the first display 110 is information that is able to be seen with bare eyes. For example, non-confidential patient information, such as a patient name, is displayed on the first display 110. Some of information displayed on a patient's electronic label in a hospital is not changed unless the patient leaves the hospital. Thus, the information displayed on the patient's electronic label does not need to be updated regularly. To reduce power consumption of the electronic label 100, the first display 110 may be embodied as the EPD 300.

There are well-known EPDs including: a twist ball-type display of Xerox, which uses a semi-spherical type twist ball with charged electrostatic charges; an electrophoretic display of E-ink, which utilizes electrophoresis and a microcapsule; and a cholesteric liquid crystal display of Kent Display. For example, the EPDs in FIG. 3 may be a product that includes: a thin film transistor (TFT) substrate having a TFT formed on a poly silicon layer deposited on a plastic substrate; a transparent electrode substrate; and a microcapsule layer sealed between the TFT substrate and the transparent electrode substrate, wherein CMOS circuits are formed by recrystallizing edges of a TFT substrate.

The first display 110 may display public information.

The second display 120 may display non-public information. Information to be displayed on the first and second display 110 and 120 may include patient information.

Throughout the following description, patient information indicates various kinds of information about a patient. Specifically, patient information includes: a patient's personal information, such as name, age, gender, blood type, disease, and the like; hospital-related information, such as a doctor in charge, a nurse in charge, admission date, discharge date, and the like; and disease-related information, such as a disease name, body temperature, blood pressure, heart rate, and the like. The patient information is not limited thereto, and may include any information that the hospital needs to know about the patient.

Meanwhile, the patient information may be determined to be public information or non-public information according to whether the information needs to be protected. Basically, patient information is open to a patient, his/her family members, a doctor in charge, and a nurse in charge. The publication or non-publication of patient information is determined according to whether any visitor or a third party is allowed to access the patient information.

The public information indicates information that does not cause a problem to personal information protection, such as privacy infringement, even in the case where the information is seen with bare eyes by any visitor or a third party as well as the patient, family members, a doctor in charge, a nurse in charge. That is, the public information is information that is able to be seen with bare eyes. For example, a patient's name, age, gender, and a doctor in charge does not cause a problem to personal information protection, such as privacy infringement, no matter who may see the information, and thus, this kind of information may be determined to be public information.

On the other hand, the non-public information is information which may cause privacy infringement in the case where the information is open to any visitor or a third party, rather than a patient, family members, a doctor in charge, and a nurse in charge. That is, the non-public information is information that is unable to be seen with bare eyes. For example, if a patient's disease name, significant medical information, or biological information is open to a third party, it may cause a problem to personal information protection, such as privacy infringement, and thus, this kind of information should be protected and may be determined to be non-public information.

However, a standard for determining a type of patient information to be public information or non-public information is not limited thereto, and any other standard may be used.

In addition, information to be displayed on the electronic label 100 may include not only patient information, but also any kind of information that can be displayed on the electronic label 100. The electronic label 100 may be used even in the case where information is divided into public information and non-public information and both types of the information need to be displayed in a single electronic label.

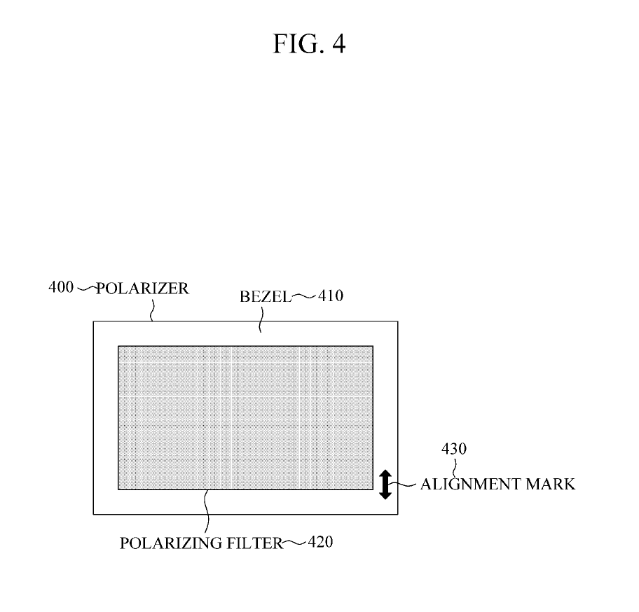

FIG. 4 is a diagram illustrating a polarizer according to an exemplary embodiment.

Referring to FIG. 4, a polarizer 400 includes a frame 410 composing a bezel, a polarizing filter 420, and an alignment mark 430 that guides a direction in which the polarizer 400 is aligned.

In one embodiment, information is able to be seen only when an additional polarizer is arranged in a consistent direction, for example, in an orthogonal or in-parallel direction, toward a polarizing filter attached on the back surface of an LCD panel. That is, the additional polarizer needs to have a polarization direction that is the same as that of a polarizing film which is to be added to the second display 120 to become a common LCD. For example, the polarizer may be in form of card in which a polarizing film is fixed onto a bezel frame.

If a polarization direction of an additional polarizer is parallel to an alignment direction of an electronic label, it may help to read information. To this end, in another embodiment, the electronic label may have a guide symbol that guides an alignment direction of a polarizer, such as an arrow and a dot. In addition, along with the guide symbol, the polarizer may include a different arrow or dot to guide an alignment direction of itself.

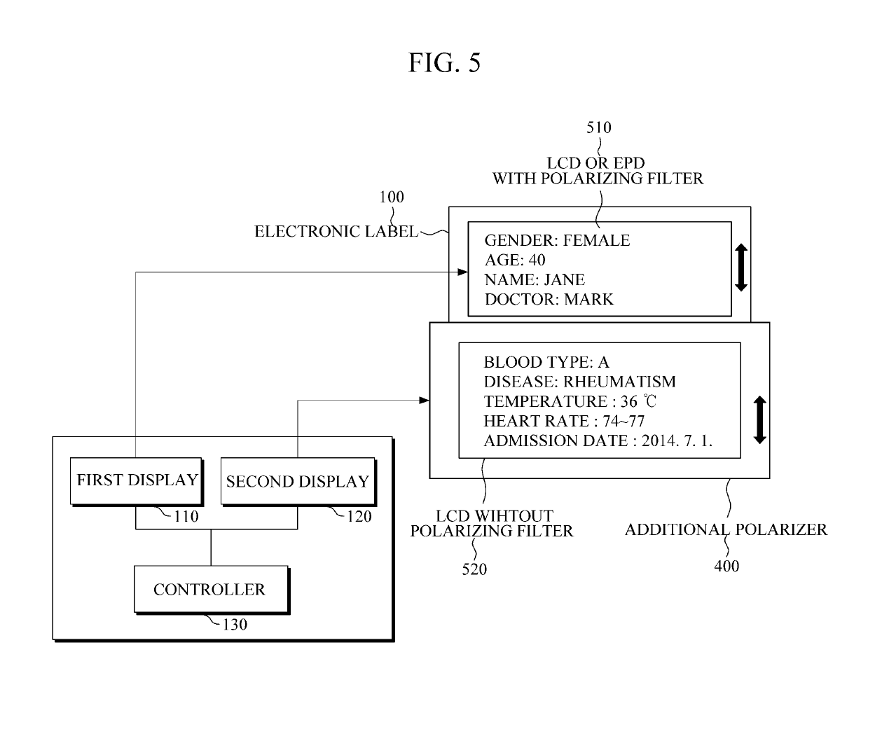

FIG. 5 is a diagram illustrating context displayed on the first display and the second display according to an exemplary embodiment.

Referring to FIG. 5, the first display 110 of an electronic label 100 may be an LCD panel with polarizing filters attached on the front surface and the back surface thereof. In another example, the first display 110 of the electronic label 100 may be an EPD. The second display 120 of the electronic label 100 may be an LCD panel with a single polarizing filter attached only on the back surface thereof.

Operations of the first display 110 and the second display 120 is controlled by the controller 130. The controller 130 may control public information to be displayed on the first display 110, while controlling non-public information to be displayed on the second display 120. For example, the controller 130 may control public information, such as a patient's name, age, gender, and doctor in charge, to be displayed on the first display 110. The controller 130 may control non-public information, such as a patient's blood type, disease name, body temperature, heart rate, and admission date, to be displayed on the second display 120. Information to be displayed on the first display 110 is able to be seen with bare eyes without any additional device. On the other hand, information to be displayed on the second display 120 is able to seen only by using an additional polarizer that allows lights vibrating in a direction indicating particular information to pass. In the above example, the non-public information, such as a patient's blood type, a disease name, body temperature, heart rate, and admission date, is able to be seen with bare eyes through an additional polarizer.

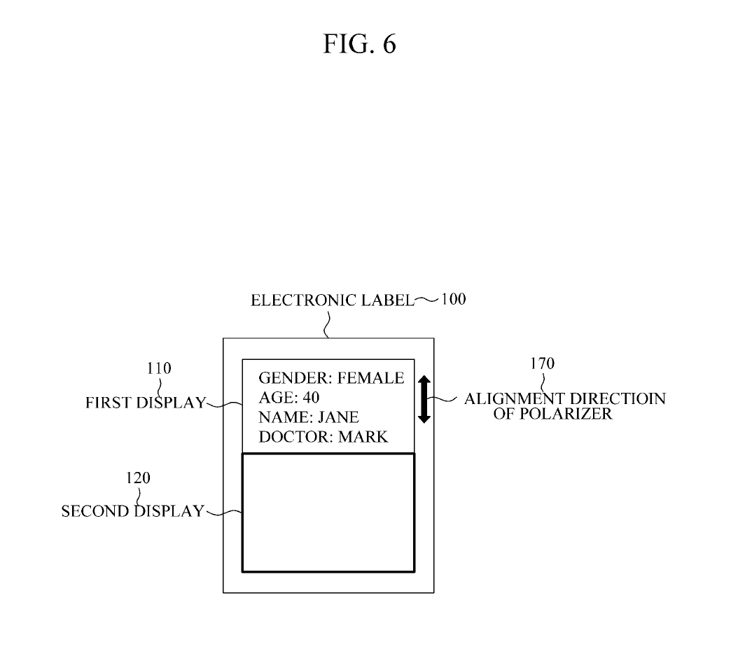

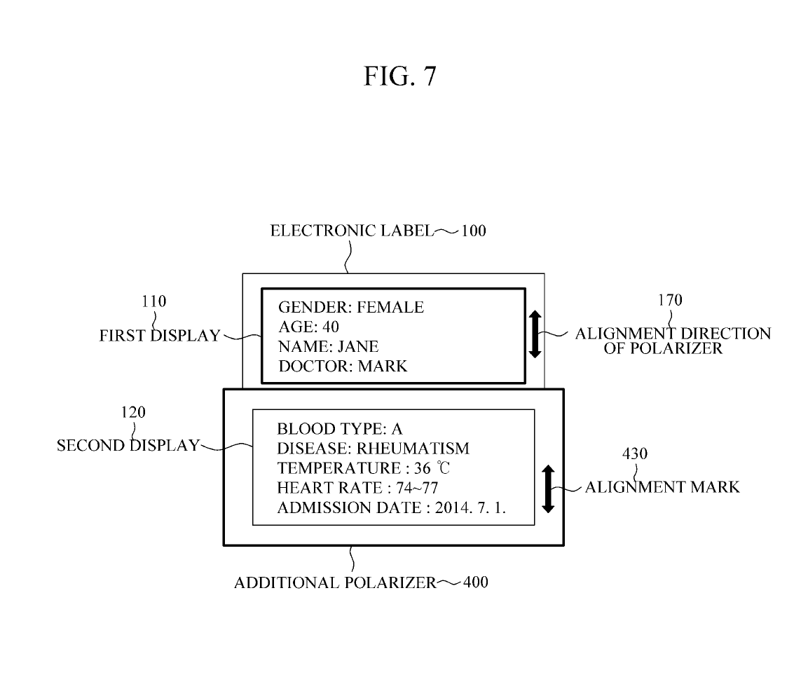

FIGS. 6 and 7 are diagrams illustrating an electronic label attached to a patient bed in the hospital according to an exemplary embodiment.

Referring to FIG. 6, an electronic label 100 displays public information on the first display 110. For example, information on a patient's name, age, gender, and a doctor in charge may be displayed on the first display 110 because there is no need to be afraid of privacy infringement even if any visitor or a third party sees the information.

The electronic label 100 displays non-public information on the second display 120. For example, information on a patient's blood type, disease name, body temperature, heart rate, and admission date, is able to be seen by patient-related people, such as family members, a doctor in charge, and a nurse in charge, but not by any visitor or a third party due to a possibility of privacy infringement. Thus, the above information may be displayed on the second display 120.

Any visitor or a third party is able to see public information displayed on the first display 110, but unable to see the non-public information displayed on the second display 120 without an additional polarizer.

Referring to FIG. 7, non-public information may be seen by putting an additional polarizer 400 close to the second display 120. For example, non-publication information, such as a patient's blood type, disease name, body temperature, heart rate, and admission date, may be seen with bare eyes by putting the additional polarizer 400 close to the second display 120. A physician or nurse in charge of the patient may use the additional polarizer 400 to see the non-public information of the patient, when necessary.

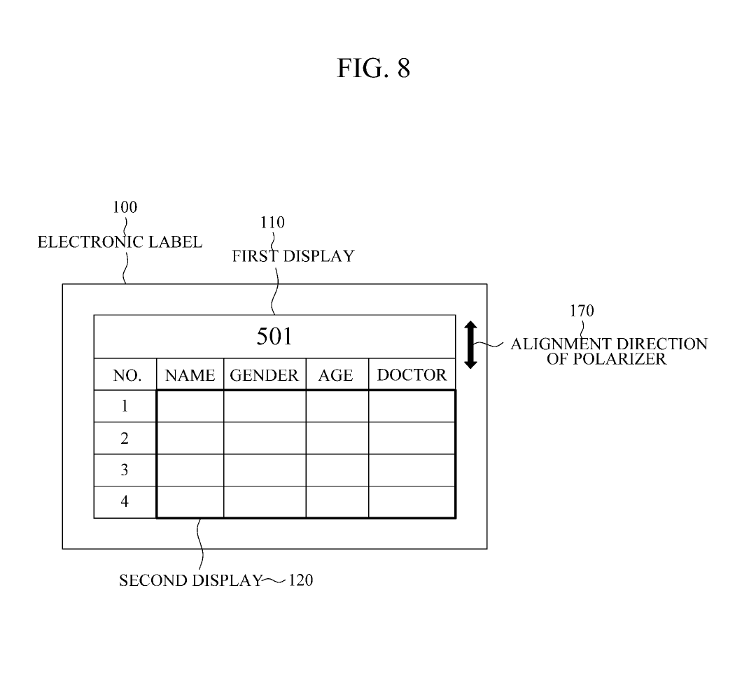

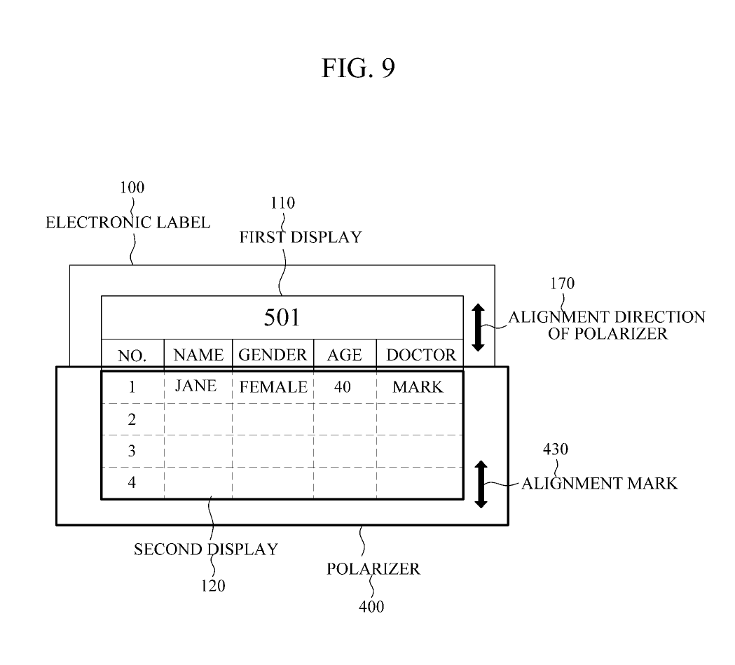

FIGS. 8 and 9 are diagrams illustrating an electronic label attached to a door of a ward in the hospital according to an exemplary embodiment. FIG. 8 shows information that is displayed directly on an electronic label, and FIG. 9 shows information that is displayed when an object with a polarizing function is put close to the second display.

Referring to FIG. 8, an electronic label 100 displays public information on the first display 110. For example, a room number and information categories are not confidential information and thus may be displayed on the first display 110.

The electronic label 100 displays non-public information on the second display 120. For example, a patient's name, gender, age, and a doctor in charge may be displayed on the second display 120 not to allow other people to see the information.

Any visitor or a third party is able to see public information displayed on the first display 110, but unable to see non-public information displayed on the second display 120 without an additional polarizer.

Referring to FIG. 9, non-public information is able to be seen with bare eyes by putting an additional polarizer 400 close to the second display 120. For example, non-public information, such as a patient's name, gender, age, and a doctor in charge, may be seen when the additional polarizer 400 is put close to the second display 120. A physician or nurse in charge of the patient may use the additional polarizer 400 to see the non-public information, when necessary.

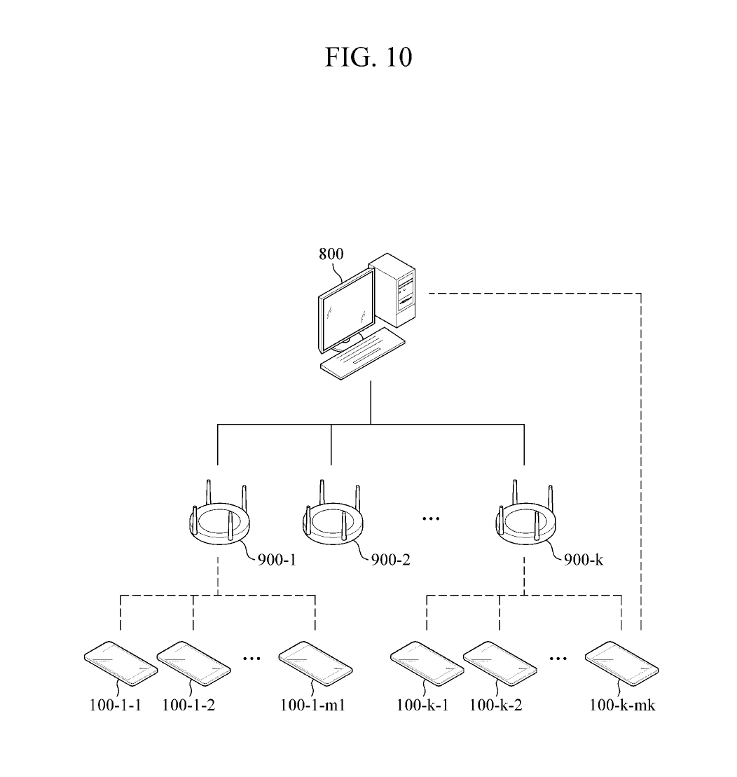

FIG. 10 is a diagram illustrating a configuration of an electronic label system according to another exemplary embodiment.

Referring to FIG. 10, an electronic label system may include a serer 800, a gateway 900, and an electronic label 100.

The server 800 stores and distributes data to manage information. For example, the server 800 divides patient information into public information and non-public information and stores the two types of information separately. Then, when information displayed on the electronic label 100 needs to be changed if the patient information is changed, the server 800 transmits, to the electronic label 100, data including information to be changed. The server 800 may include a database configured to store patient information and management information in order to manage the whole system, and a middleware configured to connect/relay the database to an external device. In addition, the server 800 acquires and stores a patient's biological information from a medical device or medical sensors, and transmits the biological information to the electronic label 100 so that the biological information may be displayed on the electronic label 100.

The gateway 900 relays information between the electronic label 100 and the server 800. The server 800 and the gateway 900 may be connected to each other over a wired network, such as Ethernet, or over a wireless network, such as WiFi or Zigbee. In this case, the gateway 900 may be an Access Point (AP).

The electronic label 100 may receive information directly from the server 800 or through the gateway 900. In the case where the electronic label 100 transmits and receives with respect to the server 800 or the gateway 900, the electronic label 100 may be connected to the server 800 or the gateway 900 over a wireless network, such as WiFi or Zigbee. If necessary, the electronic label 100 may be connected to the server 800 or the gateway 900 over a wired network.

According to one general aspect of the present invention, in the case of regularly receiving information from the server 800 or the gateway 900 through the communication module 140, the controller 130 may store the received information in the memory 150 and control public information of the received information to be displayed on the first display 110.

According to another general aspect of the present invention, in the case of regularly receiving information from the server 800 or the gateway 900 through the communication module 140, the controller 130 may store the received information in the memory 150 and control non-public information of the received information to be displayed on the second display 120.

For example, the controller 130 wakes up an electronic label 100 in response to occurrence of a timer event, and connects through the communication module 140 to the gateway 900 to check whether there is any information to be received from the server 800. If there is any information to be received from the server 800, the controller 130 receives the information from the server 800 through the gateway 900. In one embodiment, a type of the received information is determined to be public information or non-public information according to identification information included therein. If a type of the received information is determined to be public information, the controller 130 controls the received information to be displayed on the first display 110. Alternatively, if a type of the received information is determined to be non-public information, the controller 130 controls the received information to be displayed on the second display 120.

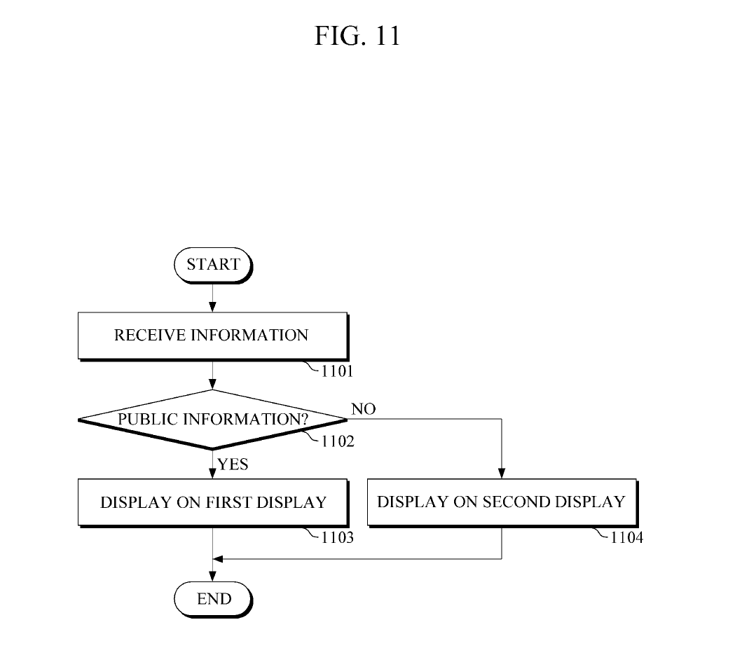

FIG. 11 is a flowchart illustrating a displaying method of an electronic label according to an exemplary embodiment.

Referring to FIG. 11, a displaying method of an electronic label according to an exemplary embodiment includes: operation 1101 in which an electronic label 100 receives information from a server 800 or a gateway 900; operation 1103 in which if the received information is public information, the electronic label 100 displays the received information on the first display 110; and operation 1104 in which if the received information is non-public information, the electronic label 100 displays the received information on the second display 120. For example, a type of the received information may be determined to be public information or non-public information according to identification information included therein. When the received information is public information, a controller 130 controls the received information to be displayed on the first display 110. Alternatively, when the received information is non-public information, the controller 130 controls the received information to be displayed on the second display 120.

The process described in the following description may be performed in various ways. The displaying methods which are provided with reference to FIGS. 11 to 13, may be a method that is performed by the electronic label shown in FIG. 1. To avoid redundancy, a displaying method of an electronic label is hereinafter described briefly. The same descriptions provided with reference to FIGS. 1 to 10 may be applied to the following descriptions although they are not exactly specified.

In 1101, the electronic label 100 receives information from the server 800 or the gateway 900. As described above with reference to FIG. 10, the electronic label 100 may receive information directly from the server 800 or through the gateway 900.

Then, in 1102, the electronic label 100 determines a type of the received information to be public information or non-public information. For example, the received information may be patient information, and a type of the patient information may be determined to be public information or non-public information according to whether the information needs to be protected.

In 1103, the electronic label 100 displays the received information on the first display 110 in the case where the received information is public information.

Alternatively, in 1104, the electronic label 100 displays the received information on the second display 120 in the case where the received information is non-public information.

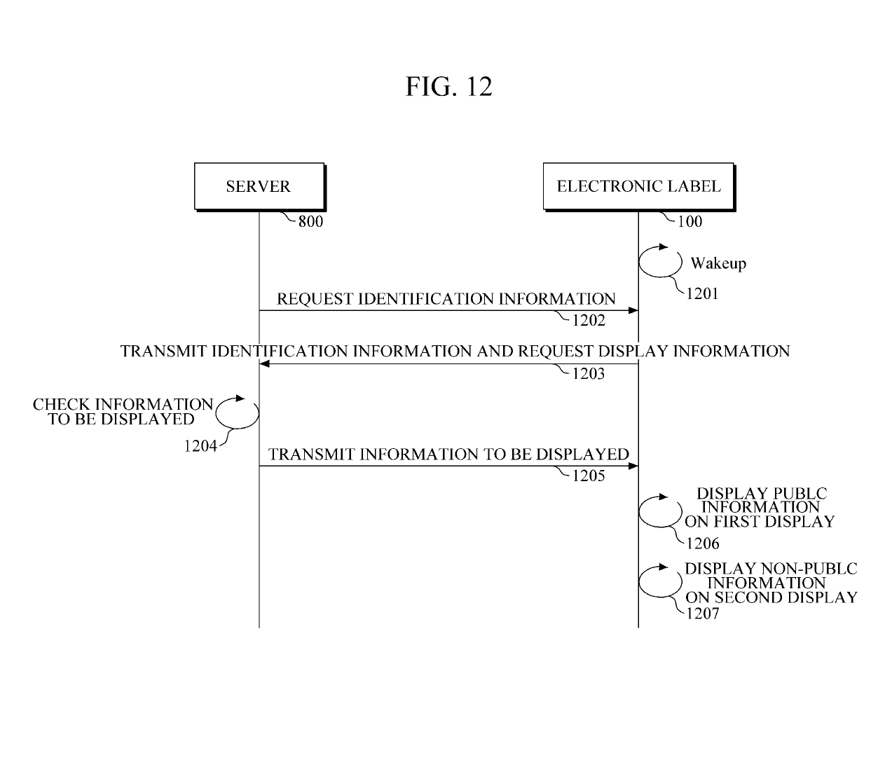

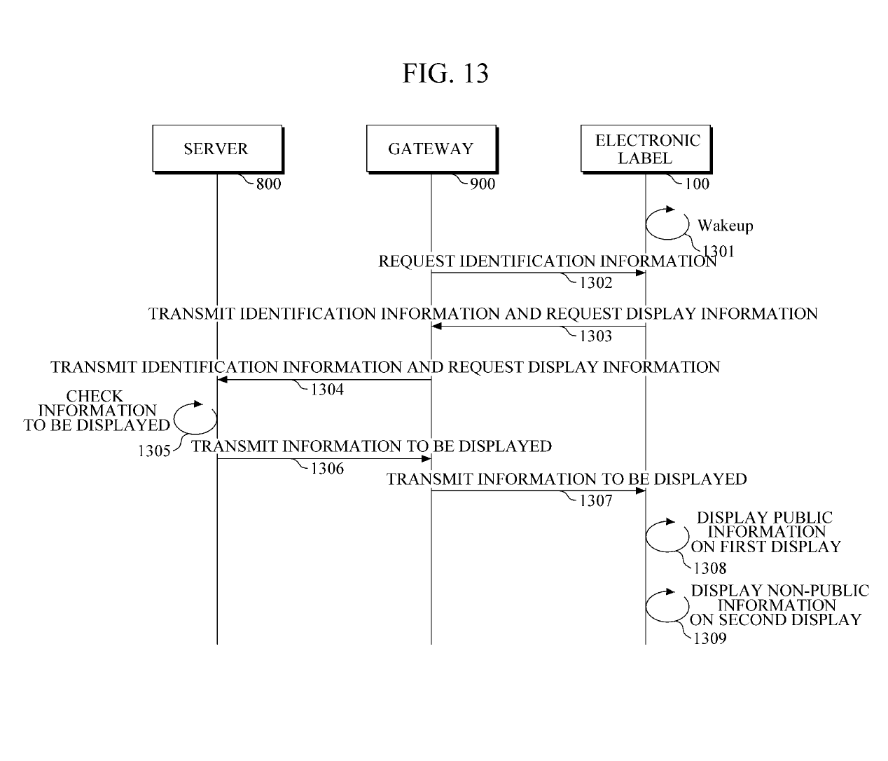

FIGS. 12 and 13 are flowcharts illustrating a displaying method of an electronic label according to another exemplary embodiment. FIG. 12 shows a method by which an electronic label receives information directly from a server, and FIG. 13 shows a method by which an electronic label receives information through a gateway from a server.

Referring to FIGS. 12 and 13, a displaying method of an electronic label includes: operation 1201 and 1301 in which the electronic label 100 wakes up by a timer 160; operation 1202 and 1302 in which the server 800 or the gateway 900 requests identification information of the electronic label 100; operation 1203 and 1303 in which the electronic label 100 transmits a display information request message including the requested identification information to the server 800 or the gateway 900; and operation 1205, 1306, and 1307 in which in response to the display information request message, the electronic label 100 receives information to be displayed from the server 800 or the gateway 900.

In 1201 and 1301, the electronic label 100 wakes up by the timer 160. The timer 160 is able to operate even when the controller 130 of the electronic label 100 is in a sleep mode. In addition, the timer 160 generates an interrupt signal at predetermined time intervals set by the controller 130 to wake up the controller 130. When the controller 130 of the electronic label 100 is woken up, the electronic label 100 is able to communicate with the server 800 or the gateway 900 through the communication module 140.

In 1202 and 1302, the server 800 or the gateway 900 requests identification information from the electronic label 100. The electronic label 100 is distinguished and managed by the server 800 according to the identification information thereof.

In 1203 and 1303, the electronic label 100 transmits a display information request message including the requested identification information to the server 800 or the gateway 900.

In 1205, 1306, and 1307, in response to the display information request message, the electronic label 100 receives information to be displayed from the server 800 or the gateway 900.

Then, the electronic label 100 determines a type of the received information to be public information or non-public information. For example, a type of the received information may be patient information. In addition, a type of the patient information may be determined to be public information or non-public information according to whether the information needs to be protected.

In the case where the identified type of the received information is public information, the electronic label 100 displays the received information on the first display 110 in 1206 and 1308,

Alternatively, in the case where the identified type of the received information is non-public information, the electronic label 100 displays the received information on the second display 120 in 1207 and 1309.

According to one general aspect of the present disclosure, the electronic label 100 may receive information periodically from the server 800 or the gateway 900 in 1205, 1306, and 1307, so that the electronic label 100 may display the latest information.

According to an exemplary embodiment, the present disclosure takes advantage of protecting personal information.

According to another exemplary embodiment, the present disclosure may achieve a long battery life by reducing power consumption of an electronic label.

According to yet another exemplary embodiment, information to be displayed on an electronic label is updated periodically to display the latest information.

A number of examples have been described above. Nevertheless, it should be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. An electronic label comprising:
a first display configured to have front and back surfaces with polarizing filters attached on the both surfaces, respectively, and display, on the front surface, information that is able to be seen with bare eyes;
a second display configured to have front and back surfaces with a polarizing filter attached only on the back surface, and display, on the front surface, information that is unable to be seen with bare eyes;
a communication module configured to communicate with a server or a gateway;
a memory configured to store information received through the communication module; and
a controller configured to control operations of the first display and the second display.

2. The electronic label of claim 1, wherein in a case where the polarizing filter is attached on part of a front surface of a single display panel, the first display is an area where the polarizing filter is attached, and the second display is an area where the polarizing filter is not attached.

3. The electronic label of claim 1, wherein the first display is an Electronic Paper Display (EPD).

4. The electronic label of claim 1, wherein the first display displays public information.

5. The electronic label of claim 1, wherein the second display displays confidential information.

6. The electronic label of claim 1, wherein the controller is further configured to, in response to periodically receiving information from the server or the gateway through the communication module, store the received information in the memory and display public information of the received information on the first display.

7. The electronic label of claim 1, wherein the controller is further configured to, in response to periodically receiving information from the server or the gateway through the communication module, store the received information in the memory and display non-public information of the received information on the second display.

8. The electronic label of claim 1, further comprising:
a guide symbol configured to guide an alignment direction of a polarizer that reads the information displayed on the second display.

9. An electronic label system comprising:
the electronic label of claim 1; and
a polarizer configured to comprise a polarizing filter and a bezel frame to which the polarizing filter is fixed, and to read information displayed on a second display of the electronic label.

10. The electronic label system of claim 9, wherein the polarizer comprises a guide symbol displayed thereon to guide an alignment direction that enables reading information displayed on the electronic label.
